(19) United States
(12) Patent Application Publication
(10) Pub. No.: US 2010/0241643 A1
(43) Pub. Date: Sep. 23, 2010

(54) MAGNETIC DISK DEVICE AND METADATA MANAGEMENT SYSTEM

(75) Inventor: Seiji TODA, Tachikawa-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/726,269

(22) Filed: Mar. 17, 2010

(30) Foreign Application Priority Data
Mar. 19, 2009 (JP) 2009-069109

(51) Int. Cl. G06F 17/30

(52) U.S. Cl. 707/758; 707/802; 707/E17.044; 707/E17.014

(57) ABSTRACT

According to one embodiment, a magnetic disk device includes: a recording medium configured to record a plurality of metadata items for each of search data items, the metadata items being related to information of the search data items; a management module configured to manage, for each of the metadata items, logical addresses specifying the metadata items recorded in the recording medium; and a reader configured to read the metadata items from the recording medium by using the logical addresses managed by the management module.

### CROSS-REFERENCE TO RELATED APPLICATIONS

This application is based upon and claims the benefit of priority from Japanese Patent Application No. 2009-069109, filed Mar. 19, 2009, the entire contents of which are incorporated herein by reference.

### BACKGROUND

1. Field

One embodiment of the invention relates to a magnetic disk device and a metadata management system.

2. Description of the Related Art

Conventionally, in order to efficiently retrieve non-text data such as voice data and moving image data, metadata that is characteristic information related to the non-text data is stored in a magnetic disk device.

When the non-text data (actual data) is retrieved from the magnetic disk device, a host device connected to the magnetic disk device reads a plurality of metadata items stored in the magnetic disk device, and obtains the actual data desired to be obtained from the read metadata items.

When the host device accesses the data in the magnetic disk device, the host device specifies a logical address (logical block address (LBA)) corresponding to a physical sector on the magnetic disk device. For example, when the host device reads a plurality of metadata items from the magnetic disk device, the host device sends a read request to the magnetic disk device to read metadata items with continuous LBAs.

Access to the data on the magnetic disk device by the host device is managed by a file manager in an operating system (OS) or by embedded software comprising the file manager. When the file manager in the operating system manages the access, the file manager specifies the LBA assigned independently of meaning of data to be written to the magnetic disk device, and sends a data write request to the magnetic disk. In other words, when a plurality of metadata items is written by the file manager of the OS, the LBAs may not be continuous.

On the other hand, when the embedded software manages the access, the embedded software may specify the LBA assigned by considering the meaning of the data to be written to the magnetic disk device, and send a data write request to the magnetic disk. In other words, when a plurality of metadata items are written by the embedded software, the LBAs may be continuous.

By the way, there is known a technique for relocating LBAs so that the LBAs become continuous, when the LBAs of a group of data (for example, a file) are not continuous. For example, the magnetic disk device duplicates information of continuous LBAs of a transfer destination in a temporary area (dummy sector), and duplicates information of LBAs of a transfer source to the LBAs of the transfer destination, so that the magnetic disk device relocates the LBAs of data to be continuous, without transferring/receiving data with respect to the host device.

The magnetic disk device dually manages a plurality of logical addresses provided so that sectors constituting a file become logically continuous and a plurality of LBAs corresponding to physical sectors on the magnetic disk, so that the magnetic disk device relocates LBAs to be continuous when the LBAs corresponding to the logical addresses specified by the host device are separately located.

Reference may be had to, for example, Japanese Patent Application Publication (KOKAI) No. 2005-267240, and Japanese Patent Application Publication (KOKAI) No. 2004-334419.

However, a conventional magnetic disk device cannot read a plurality of metadata items efficiently.

Specifically, even when LBAs of the metadata items are continuous, physical sectors corresponding to the LBAs may not be continuous. Therefore, the magnetic disk device takes time for a seek operation and a rotation waiting operation to read each physical sector corresponding to the LBAs of the metadata items.

For example, when there is a defect in a physical sector in adjacent physical sectors, an alternate sector may be used. In this case, the alternate sector is normally located in a separate storage area. Therefore, when the metadata items are stored in sectors comprising an alternate sector, it takes time for the magnetic disk device to perform the seek operation and the rotation waiting operation to read the metadata items stored in the alternate sector.

In the conventional magnetic disk device in which a coherent file is rearranged to continuous LBAs by using the dummy sector, the coherent file is not rearranged to be adjacent physical sectors.

In addition, in the conventional magnetic disk device which dually manages the logical addresses and the LBAs, the coherent file is not rearranged to be continuous physical sectors.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of a metadata management system according to a first embodiment of the invention;

FIG. 2 is an exemplary block diagram of the metadata management system in the first embodiment;

FIG. 3 is an exemplary metadata management table in the first embodiment;

FIG. 4 is an exemplary flowchart of data write processing of a host device in the first embodiment;

FIG. 5 is an exemplary flowchart of data write processing of a magnetic disk device in the first embodiment;

FIG. 6 is an exemplary flowchart of metadata batch read processing in the first embodiment;

FIG. 7 is an exemplary flowchart illustrating a use example of the metadata management system in the first embodiment;

FIG. 8 is an exemplary schematic diagram a metadata management system according to a second embodiment of the invention;

FIG. 9 is an exemplary block diagram of the metadata management system in the second embodiment;

FIG. 10 is an exemplary diagram of a metadata management table in the second embodiment;

FIG. 11 is an exemplary flowchart of data write processing of the magnetic disk device in the second embodiment; and

FIG. 12 is an exemplary flowchart illustrating a use example of the metadata management system in the second embodiment.

### DETAILED DESCRIPTION

Various embodiments according to the invention will be described hereinafter with reference to the accompanying drawings. In general, according to one embodiment of the invention, a magnetic disk device comprises: a recording medium configured to record a plurality of metadata items for each of search data items, the metadata items being related to information of the search data items; a management module configured to manage, for each of the metadata items, logical addresses specifying the metadata items recorded in the recording medium; and a reader configured to read the metadata items from the recording medium by using the logical addresses managed by the management module.

According to another embodiment of the invention, a metadata management system, comprises: a magnetic disk device comprising a recording medium configured to record a plurality of metadata items for each of search data items, the metadata items being related to information of the search data items; and a host device configured to transmit a request to the magnetic disk device. The host device comprises a read request module that is configured to output a read request to read the metadata items. The magnetic disk device comprises: a management module that is configured to manage, for each of the metadata items, logical addresses specifying the metadata items recorded in the recording medium; a reader that is configured to read, when the reader detects the read request from the read request module, the metadata items by using the logical addresses managed by the management module; and an output module that is configured to output to the host device the metadata items read by the reader, along with the logical addresses specifying the metadata items.

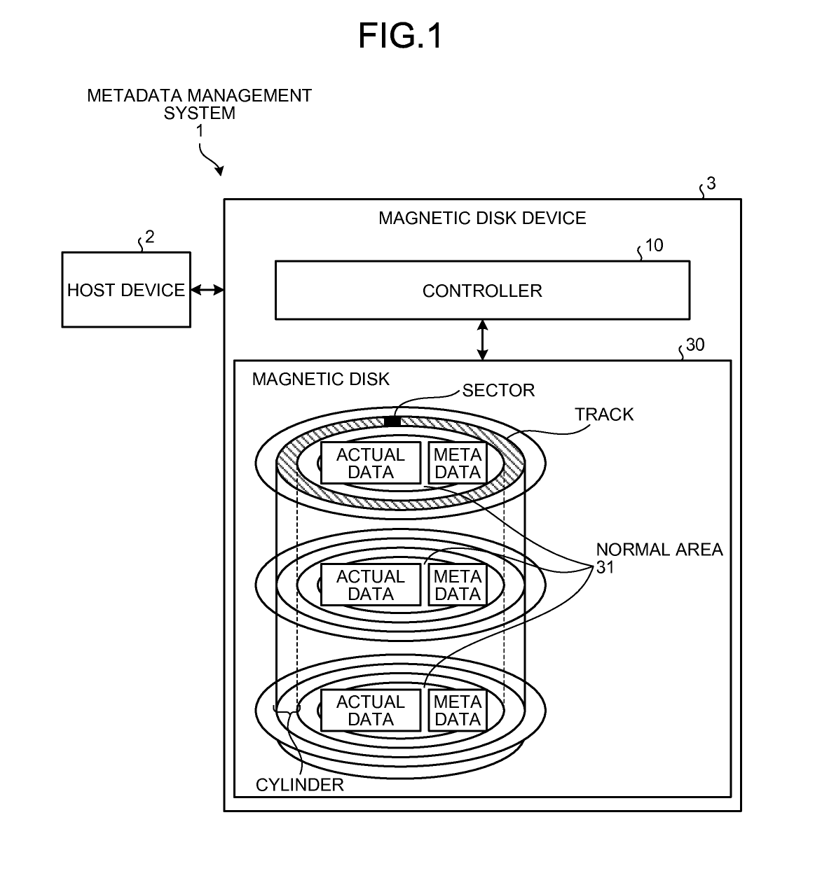

FIG. 1 is a diagram for illustrating an outline of a metadata management system according to a first embodiment. As illustrated in FIG. 1, a metadata management system 1 comprises a host device 2 and a magnetic disk device 3 connected to the host device 2.

In the metadata management system 1, when the magnetic disk device 3 receives a request to batch read metadata items related to information of search data items from the host device 2, the magnetic disk device 3 batch reads the metadata items to be read efficiently. Then, the magnetic disk device 3 sends a response including the result to the host device 2. When the magnetic disk device 3 receives one of the metadata items related to one of the search data items requested to be retrieved by the host device 2 from among the batch read metadata items, the magnetic disk device 3 retrieves the one of the search data items corresponding to the one of the metadata items, and responds to the host device 2.

The host device 2 in the metadata management system 1 issues various request commands for read/write processing related to metadata to the magnetic disk device 3, in order to read/write metadata and actual data corresponding to the metadata with respect to the magnetic disk device 3.

The actual data is the search data to be retrieved, and the actual data is, for example, binary data, but not text data. The actual data comprises, for example, moving image data and voice data, but the actual data is not limited thereto.

The magnetic disk device 3 comprises a controller 10 and a magnetic disk 30.

When the controller 10 receives the various request commands for read/write processing related to metadata from the host device 2, the controller 10 performs various processing operations on the magnetic disk 30 in accordance with the request commands, and responds to the host device 2 with the processing result.

Specifically, when the controller 10 receives a request command to batch read metadata from the host device 2, the controller 10 batch reads a plurality of metadata items stored in the magnetic disk 30 from the magnetic disk 30 by using a metadata management table, and outputs the result to the host device 2. The metadata management table is a table which manages each metadata item stored in the magnetic disk 30 by using logical block addresses (LBAs) specifying the storage areas of the metadata items. The processing performed by the controller 10 will be described below in detail.

The magnetic disk 30 is a storage medium that stores a plurality of actual data items and a plurality of metadata items related to the actual data items. Specifically, concentric tracks are formed on each recording surface (platter) of the magnetic disk 30. A group of tracks having the same radius on each platter is called “cylinder”. Each track is divided in a radial fashion from the center of the concentric circles, and forms physical sectors. This physical sector is a unit of read/write operation from/to the magnetic disk 30. The physical sector is a storage area represented by, for example, a physical address calculated with a platter number, a cylinder number, and a sector number, and the physical sector is associated with the LBA. The actual data and the metadata are stored in the physical sectors, and the controller 10 reads/writes the actual data and metadata from/to the physical sectors by using the LBAs which are associated with the physical addresses representing the physical sectors in which the actual data and the metadata are stored. An area on the magnetic disk 30 managed by the LBAs in this way is referred to as “normal area 31”.

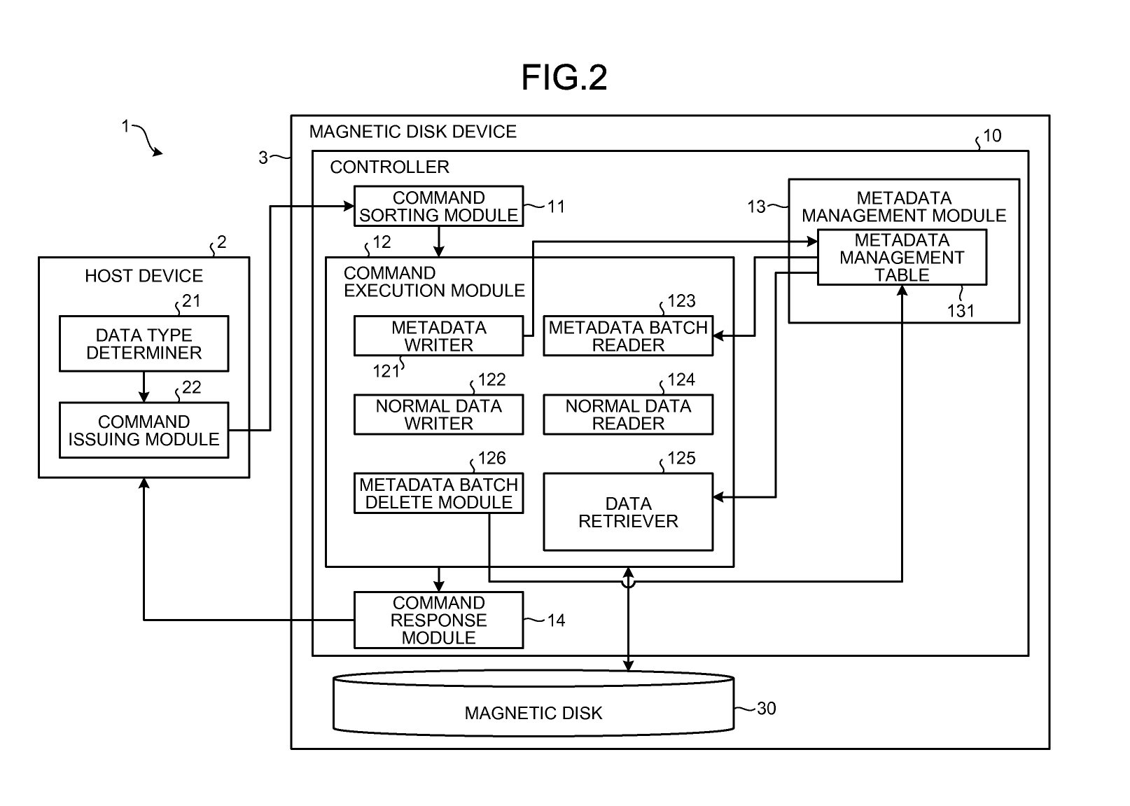

FIG. 2 is a functional block diagram illustrating a configuration of the metadata management system according to the first embodiment. As illustrated in FIG. 2, the host device 2 comprises a data type determiner 21 and a command issuing module 22.

When the data type determiner 21 writes the metadata or the actual data to the magnetic disk 30, the data type determiner 21 determines a data type which indicates whether the data to be written is the metadata or the actual data. For example, the data type determiner 21 determines the data type of the data by referring to an extension added to a data name specified for each metadata item and each actual data item in advance. The data type determiner 21 outputs an instruction to write data to the magnetic disk device 3 along with a data type to the command issuing module 22.

The data type determiner 21 is assumed to be installed in software which handles metadata and actual data. Although the data type determiner 21 is assumed to distinguish metadata and actual data by referring to the extension, the data type determination is not limited thereto.

The command issuing module 22 issues various request commands for read/write processing related to metadata to the magnetic disk device 3.

Specifically, when the command issuing module 22 detects an instruction to write data to the magnetic disk device 3 from the data type determiner 21, the command issuing module 22 outputs a metadata save command (for example, “Meta Write” command) to the magnetic disk device 3 when the data type of the data is metadata. In this case, the command issuing module 22 outputs the metadata save command comprising parameters of an LBA specifying the metadata to be written, the metadata, and an LBA of the actual data corresponding to the metadata, to the magnetic disk device 3.

On the other hand, when the data type is the actual data, the command issuing module 22 outputs “Write” command defined by a standard interface specification related to a connection with the magnetic disk device 3, such as serial advanced technology attachment (SATA) and serial attached small computer system interface (serial attached SCSI; SAS) to the magnetic disk device 3.

When the command issuing module 22 detects an instruction to batch read metadata stored in the magnetic disk 30, the command issuing module 22 outputs a metadata batch read command (for example, “Meta All Read” command) corresponding to the instruction to the magnetic disk device 3.

The request commands comprise not only the metadata save command and the metadata batch read command, but also a metadata read command (for example, “Meta Read” command) to read a single metadata item from the magnetic disk device 3.

In addition, there are a metadata delete command (for example, “Meta Delete” command) to delete a single metadata information item from a metadata management table 131, and a metadata batch delete command (for example, “Meta All Delete” command) to delete all metadata items from the metadata management table 131.

Furthermore, the request commands comprise a corresponding data search command (for example, “Get Data LBA” command) to search an LBA of actual data corresponding to a single metadata item from the metadata management table 131. The request commands are not limited to the above commands, but may be commands related to metadata.

Although the command issuing module 22 issues the request command to the magnetic disk device 3, the command issuing module 22 may issue a command which uses the standard interface specification to the magnetic disk device 3. For example, when issuing a metadata save command, the command issuing module 22 may use not only a dedicated command for metadata, but also the “Write” command, in which the data type, the LBA specifying the metadata, the metadata, and the LBA of the actual data corresponding to the metadata are specified as parameters.

Although, the command issuing module 22 is normally installed in the OS, the command issuing module 22 may be installed in software embedded in the software which handles metadata and actual data.

The controller 10 comprises a command sorting module 11, a command execution module 12, a metadata management module 13 comprising the metadata management table 131, and a command response module 14.

The command sorting module 11 sorts various request commands issued from the command issuing module 22 in accordance with the type of the command, and outputs the commands to the command execution module 12.

When the command execution module 12 receives the command sorted by the command sorting module 11, the command execution module 12 performs processing according to the received command. The command execution module 12 comprises a metadata writer 121, a normal data writer 122, a metadata batch reader 123, a normal data reader 124, a data retriever 125, and a metadata batch delete module 126.

When the metadata writer 121 receives the metadata save command from the command sorting module 11, the metadata writer 121 writes the metadata comprised in parameters to the normal area 31 of the magnetic disk 30 on the basis of the parameters of the received command.

Specifically, the metadata writer 121 receives an LBA specifying the metadata, the metadata, and an LBA of the actual data corresponding to the metadata as the parameters. The metadata writer 121 writes the metadata comprised in the received parameters to the normal area 31 so as to use the LBA specifying the metadata. At this time, the metadata writer 121 associates the LBA specifying the metadata and the LBA of the actual data corresponding to the metadata with each other, and stores both LBAs in the metadata management table 131 that manages the metadata. Further, the metadata writer 121 outputs the write result to the command response module 14.

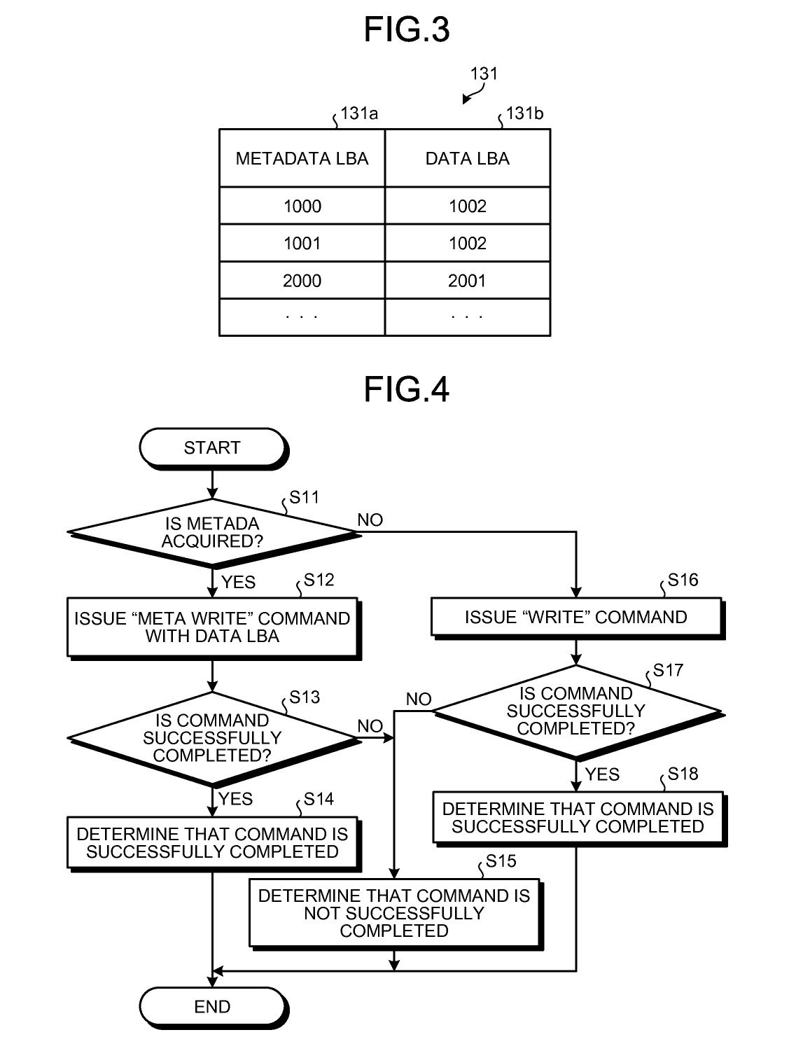

An example of a data structure of the metadata management table 131 will be described with reference to FIG. 3. FIG. 3 is a diagram illustrating the data structure of the metadata management table according to the first embodiment. As illustrated in FIG. 3, the metadata management table 131 comprises, for example, metadata LBAs 131a and data LBAs 131b.

The metadata LBA 131a is an LBA that specifies a storage area of the metadata stored in the normal area 31 of the magnetic disk 30. The data LBA 131b is an LBA that specifies a storage area of the actual data which corresponds to the metadata and is stored in the normal area 31 of the magnetic disk 30. All the metadata items stored in the normal area 31 of the magnetic disk 30 can be recognized by the metadata management table 131.

Referring back to FIG. 2, when the normal data writer 122 receives the “Write” command defined by the standard interface specification from the command sorting module 11, the normal data writer 122 writes the actual data comprised in parameters to the normal area 31 of the magnetic disk 30 on the basis of the parameters of the received command.

Specifically, the normal data writer 122 receives the actual data and an LBA specifying the actual data, as the parameters. The normal data writer 122 writes the actual data comprised in the received parameters to the normal area 31 so as to use the LBA specifying the actual data. Further, the normal data writer 122 outputs the write result to the command response module 14.

Although the normal data writer 122 writes the actual data to the normal area 31 of the magnetic disk 30, when the metadata is already written to the normal area 31, the normal data writer 122 may receive the LBA of the metadata as a parameter and update the metadata in the normal area 31 of the magnetic disk 30.

When the metadata batch reader 123 receives the metadata batch read command from the command sorting module 11, the metadata batch reader 123 batch reads the metadata managed by the metadata management table 131 from the normal area 31 of the magnetic disk 30 by using the metadata management table 131.

Specifically, the metadata batch reader 123 reads all the LBAs which are stored in the metadata management table 131 and specify the metadata items. The metadata batch reader 123 reads the metadata items from the storage areas specified by the LBAs in the normal area 31 in ascending order of physical addresses corresponding to the read LBAs. Further, the metadata batch reader 123 outputs all the metadata items read from the normal area 31 along with the LBAs of the metadata items to the command response module 14. In this way, the metadata batch reader 123 can batch read the metadata items managed by the metadata management table 131 from the normal area 31 of the magnetic disk 30. Although, the metadata batch reader 123 reads the metadata items in ascending order of physical addresses corresponding to the LBAs that specify a plurality of metadata items, the metadata batch reader 123 may read the metadata items efficiently in accordance with the characteristics of the seek operation and the rotation waiting operation of the magnetic head.

When the normal data reader 124 receives a “Read” command defined by the standard interface specification from the command sorting module 11, the normal data reader 124 reads the actual data from the normal area 31 of the magnetic disk 30 by using an LBA which is comprised in the parameters of the received command and specifies the actual data. Further, the normal data reader 124 outputs the read actual data to the command response module 14. The “Read” command generally means a command to read user data defined in the standard interface specification, and there may be a plurality of “Read” commands.

When the data retriever 125 receives the corresponding data retrieve command from the command sorting module 11, the data retriever 125 reads an LBA of the actual data corresponding to the metadata comprised in the parameters from the metadata management table 131 on the basis of the parameters of the received command.

Specifically, the data retriever 125 receives an LBA specifying the metadata as the parameter. Then, the data retriever 125 reads the LBA of the actual data corresponding to the metadata from the metadata management table 131 by using the received LBA specifying the metadata. Further, the data retriever 125 outputs the read LBA that specifies the actual data to the command response module 14.

Although the data retriever 125 reads the LBA of the actual data corresponding to the metadata from the metadata management table 131, the data retriever 125 may further read the actual data from the normal area 31 by using the read LBA of the actual data.

When the metadata batch delete module 126 receives the metadata batch delete command from the command sorting module 11, the metadata batch delete module 126 deletes all the metadata items from the metadata management table 131, and initializes the metadata management table 131.

When the command response module 14 receives a processing result from the command execution module 12, the command response module 14 outputs the received processing result to the command issuing module 22.

Next, data write processing in the host device 2 according to the first embodiment will be described with reference to FIG. 4. FIG. 4 is a flowchart of the data write processing of the host device according to the first embodiment. In the data write processing of FIG. 4, data is written to the magnetic disk device 3 by software which handles metadata and actual data.

First, when the data outputted by a processing module which requests the data write processing in the software is received by the data type determiner 21, the data type determiner 21 determines the data type of the received data (S11). Specifically, the data type determiner 21 determines whether the data type of the data is metadata or actual data by, for example, recognizing the extension added to the name of the data.

When the data type of the data is determined to be the metadata (Yes at S11), the command issuing module 22 issues the metadata save command (for example, “Meta Write” command) to the magnetic disk device 3 (S12). At this time, the command issuing module 22 outputs the metadata save command comprising as parameters the metadata, the LBA specifying the metadata, and the LBA specifying the actual data corresponding to the metadata, to the magnetic disk device 3.

Thereafter, the command issuing module 22 receives a response to the metadata save command from the magnetic disk device 3, and determines whether the received response result is normal (S13).

When the response result is determined to be normal (Yes at S13), the command issuing module 22 determines that the command is successfully completed (S14), and outputs a processing result to the processing module which has requested the data write processing.

When the response result is determined to be abnormal (No at S13), the command issuing module 22 determines that the command is not successfully completed (S15), and outputs a processing result to the processing module which has requested the data write processing.

On the other hand, when the data type of the data is determined not to be metadata (No at S11), the command issuing module 22 determines that the data is the actual data, and issues the “Write” command defined by the standard interface specification to the magnetic disk device 3 (S16). At this time, the command issuing module 22 issues the “Write” command comprising, as parameters, the actual data and an LBA specifying the actual data, to the magnetic disk device 3. In general, the “Write” command is a command to write user data defined in the standard interface specification, and there may be a plurality of “Write” commands.

Thereafter, the command issuing module 22 receives a response to the “Write” command from the magnetic disk device 3, and determines whether the received response result is normal (S17).

When the response result is determined to be normal (Yes at S17), the command issuing module 22 determines that the command is successfully completed (S18), and outputs a processing result to the processing module which has requested the data write processing.

When the response result is determined to be abnormal (No at S17), the command issuing module 22 determines that the command is not successfully completed (S15), and outputs a processing result to the processing module which has requested the data write processing.

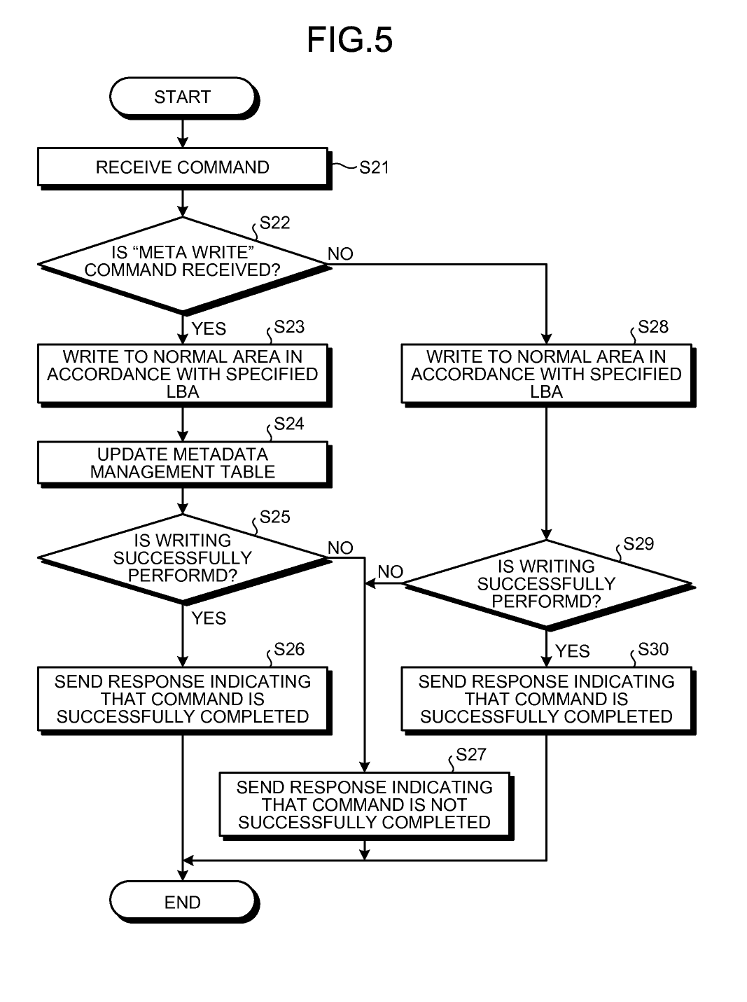

Next, data write processing in the magnetic disk device 3 according to the first embodiment will be described with reference to FIG. 5. FIG. 5 is a flowchart of the data write processing of the magnetic disk device according to the first embodiment.

First, when a command issued by the command issuing module 22 of the host device 2 is received by the command sorting module 11 (S21), the command sorting module 11 determines whether the received command is the metadata save command (for example, “Meta Write” command) (S22).

When the command sorting module 11 determines that the received command is the metadata save command (for example, “Meta Write” command) (Yes at S22), the metadata writer 121 receives the parameters of the metadata save command comprising the metadata, the LBA specifying the metadata, and the LBA specifying the actual data corresponding to the metadata. Then, the metadata writer 121 writes the metadata to the normal area 31 so as to use the LBA specifying the metadata in accordance with the received parameters (S23).

The metadata writer 121 associates the LBA specifying the metadata and the LBA specifying the actual data corresponding to the metadata with each other, and stores both LBAs in the metadata management table 131 (S24).

Thereafter, the command response module 14 receives a response result of the metadata write processing from the metadata writer 121, and determines whether the received response result indicates that the write processing is successfully performed (S25).

When the response result indicates that the write processing is successfully performed (Yes at S25), the command response module 14 sends a response to the command issuing module 22 of the host device 2 indicating that the metadata save command is successfully completed (S26).

When the response result indicates failure in the write processing (No at S25), the command response module 14 send a response to the command issuing module 22 of the host device 2 indicating that the “Meta Write” command is not successfully completed (S27).

On the other hand, when the command sorting module 11 determines that the command is not the metadata save command (for example, “Meta Write” command) (No at S22), the normal data writer 122 determines that the command is the “Write” command, and receives the parameters of the “Write” command comprising the actual data and the LBA specifying the actual data. Then, the normal data writer 122 writes the actual data to the normal area 31 so as to use the LBA specifying the actual data in accordance with the received parameters (S28).

The normal data writer 122 may write not only the actual data but also the metadata to the normal area 31. In this case, the normal data writer 122 receives the LBA specifying the metadata and the metadata as the parameters of the “Write” command, and writes the metadata to the normal area 31 so as to use the LBA specifying the metadata.

Thereafter, the command response module 14 receives a response result of the actual data write processing from the normal data writer 122, and determines whether the received response result indicates that the write processing is successfully performed (S29).

When the response result indicates that the write processing is successfully performed (Yes at S29), the command response module 14 send a response indicating that the “Write” command is successfully completed, to the command issuing module 22 of the host device 2 (S30).

When the response result indicates failure in the write processing (No at S29), the command response module 14 send a response indicating that the “Write” command is not successfully completed, to the command issuing module 22 of the host device 2 (S27).

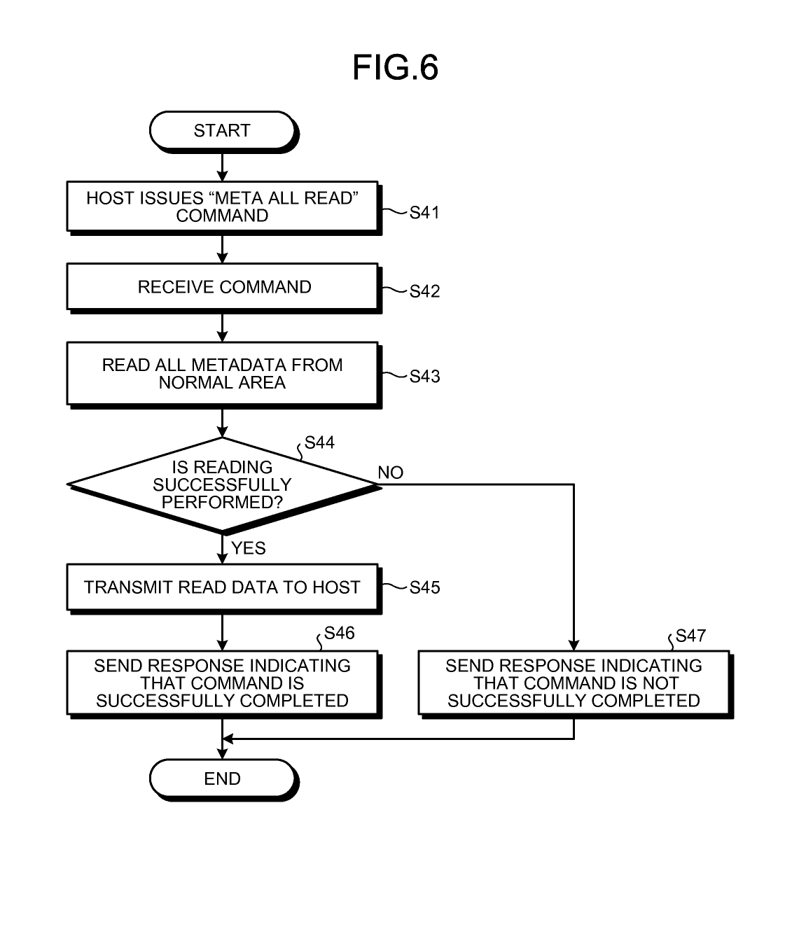

Next, the metadata batch read processing according to the first embodiment will be described with reference to FIG. 6. FIG. 6 is a flowchart of the metadata batch read processing according to the first embodiment.

First, the command issuing module 22 of the host device 2 issues the metadata batch read command (for example, “Meta All Read” command) to the magnetic disk device 3 (S41).

Then, the command issued by the command is suing module 22 of the host device 2 is received by the command sorting module 11 (S42).

The metadata batch reader 123 batch reads the metadata items managed by the metadata management table 131 from the normal area 31 of the magnetic disk 30 by using the metadata management table 131 (S43). Specifically, the metadata batch reader 123 reads all the LBAs specifying the metadata items from the metadata management table 131. Then, the metadata batch reader 123 reads all the metadata items specified by the LBAs from the normal area 31 in ascending order of physical addresses corresponding to the read LBAs.

Thereafter, the command response module 14 receives a response result of the metadata batch read processing from the metadata batch reader 123, and determines whether the received response result indicates that the batch read processing is successfully performed (S44).

When the response result indicates that the batch read processing is successfully performed (Yes at S44), the command response module 14 sends all of the read metadata items to the command issuing module 22 of the host device 2 as a response result (S45). The, when the host device 2 receives all of the read metadata items as the response result, the host device 2 determines that the metadata batch read processing is successfully performed (S46).

On the other hand, when the response result indicates failure in the batch read processing (No at S44), the command response module 14 send a response indicating that the “Metadata Batch Read” command is not successfully completed, to the command issuing module 22 of the host device 2 (S47). When the host device 2 receives the response result indicating that the command is not successfully completed (abnormal completion) from the command response module 14, the host device 2 determines that the metadata batch read processing is abnormal.

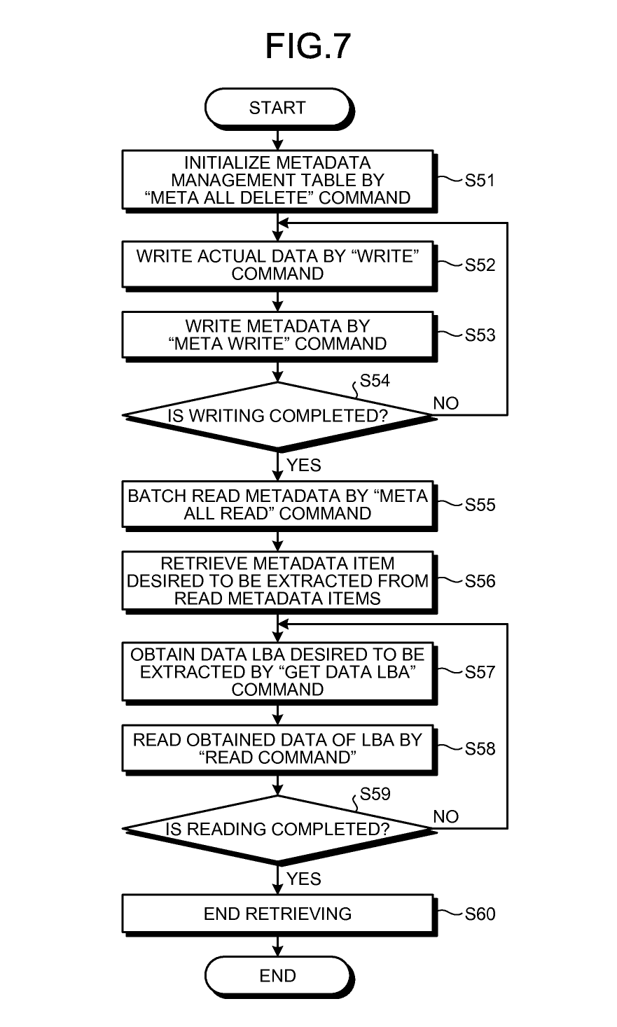

Next, a use example of the metadata management system according to the first embodiment will be described with reference to FIG. 7. FIG. 7 is a flowchart illustrating the use example of the metadata management system according to the first embodiment. In FIG. 7, S51 to S54 are pre-processing for storing the metadata and the actual data corresponding to the metadata in the normal area 31 of the magnetic disk 30, and from S55 to S60 are post-processing for retrieving an actual data item corresponding to one metadata item among all of the metadata items stored in the normal area 31. The post-processing may be used continuously from the pre-processing, but need not be used continuously from the pre-processing.

First, to initialize the metadata management table 131, the command issuing module 22 of the host device 2 issues the metadata batch delete command (“Meta All Delete” command). Then, the metadata batch delete module 126 of the magnetic disk device 3 deletes all the metadata items listed in the metadata management table 131 (S51).

Next, to store the actual data to the magnetic disk 30, the command issuing module 22 of the host device 2 issues the “Write” command. Then, the normal data writer 122 stores the actual data specified by the command in the normal area 31 of the magnetic disk 30 (S52).

Next, to store the metadata related to the actual data to the magnetic disk 30, the command issuing module 22 of the host device 2 issues the metadata save command (“Meta Write” command). Then, the metadata writer 121 stores the metadata specified by the command in the normal area 31 of the magnetic disk 30 (S53). At this time, the metadata writer 121 associates the metadata specified by the command and the actual data corresponding to the metadata with each other by using the LBAs of both data, and stores both LBAs in the metadata management table 131.

The host device 2 determines whether the write processing of the actual data to the magnetic disk 30 is completed (S54).

When the write processing of the actual data to the magnetic disk 30 is not completed (No at S54), the host device 2 again performs S52 to continuously store the actual data still not written in the magnetic disk 30.

On the other hand, when the host device 2 determines that the write processing of the actual data to the magnetic disk 30 is completed (Yes at S54), the host device 2 completes the write processing. Thereafter, to read all the metadata items stored in the normal area 31 of the magnetic disk 30, the command issuing module 22 of the host device 2 issues the metadata batch read command (“Meta All Read” command). Then, the metadata batch reader 123 reads all the metadata items listed in the metadata management table 131 from the magnetic disk 30 (S55), and send a response including all of the read metadata items and the LBAs thereof, to the host device 2.

Then, the host device 2 retrieves a metadata item related to an actual data information desired to be extracted, from all of the metadata items read by the magnetic disk device 3 (S56).

In order to obtain the LBA of the actual data corresponding to the retrieved metadata item, the command issuing module 22 of the host device 2 issues the corresponding data retrieve command (“Get Data LBA” command). Then, the data retriever 125 reads the LBA of the actual data corresponding to the metadata from the metadata management table 131 (S57) by using the LBA which is specified by the command and specifies the metadata, and send a response including read LBA of the actual data to the host device 2.

Further, to read the actual data from the magnetic disk 30, the command issuing module 22 of the host device 2 issues the “Read” command. Then, the normal data reader 124 reads the actual data from the normal area 31 of the magnetic disk 30 (S58) by using the LBA of the actual data which is specified by the command, and send a response including the read actual data to the host device 2.

The host device 2 determines whether the read processing of the actual data desired to be extracted from the magnetic disk 30 is completed (S59).

When the host device 2 determines that the read processing of the actual data desired to be extracted from the magnetic disk 30 is not completed (No at S59), the host device 2 again performs S57 to continuously read the actual data still not read from the magnetic disk 30.

On the other hand, when the host device 2 determines that the read processing of the actual data desired to be extracted from the magnetic disk 30 is completed (Yes at S59), the host device 2 completes the read processing of the actual data (S60).

As described above, the magnetic disk 30 of the first embodiment stores a plurality of metadata items, which are related to the actual data information to be retrieved, for each actual data item, manages the LBAs specifying the metadata items stored in the magnetic disk 30 for each of the metadata items, and reads a plurality of metadata items related to the actual data items from the magnetic disk 30 by using the managed logical addresses specifying the metadata items.

According to such a configuration, the magnetic disk device 3 manages the metadata items stored in the magnetic disk 30 by the metadata management table 131, so that the magnetic disk device 3 can recognize physical addresses on the magnetic disk 30 corresponding to the LBAs of each metadata item, and can efficiently read the metadata items. As a result, the magnetic disk device 3 can largely suppress the seek time and the rotation waiting time, and hence it is possible to significantly improve the performance of the batch read processing of the metadata. Further, the magnetic disk device 3 can optimize the performance of the batch read processing of the metadata without changing operations of existing BIOS, OS, and the like of the host device.

In the first embodiment, the magnetic disk device 3 manages the metadata stored in the normal area 31 where the metadata and the actual data coexist by using the metadata management table. However, the magnetic disk device 3 may manage the metadata stored in a metadata save area 32 which is different from the normal area 31 where the metadata and the actual data are mixed and stored, and dedicatedly stores the metadata, by using the metadata management table.

In the second embodiment, the magnetic disk device 3 manages the metadata stored in the metadata save area 32 which is different from the normal area 31 where the metadata and the actual data are mixed and stored, and dedicatedly stores the metadata, by using the metadata management table.

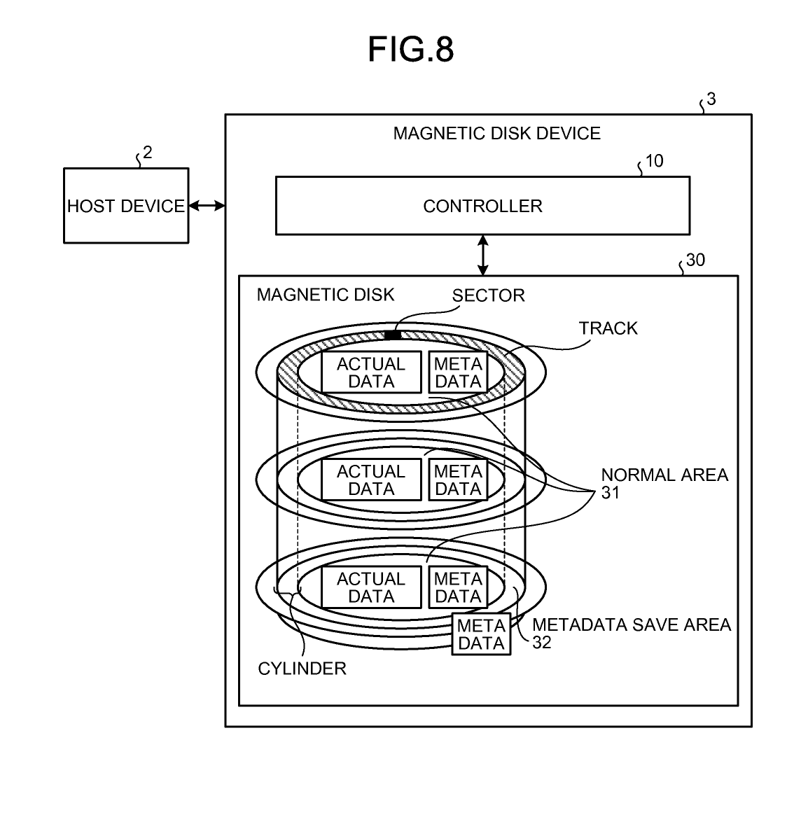

First, an outline of the metadata management system according to the second embodiment will be described with reference to FIG. 8. FIG. 8 is a diagram illustrating the outline of the metadata management system according to the second embodiment. As illustrated in FIG. 8, the magnetic disk 30 in the metadata management system 1 (FIG. 1) is changed. In FIG. 8, the same portions as those in FIG. 1 are given the same reference numerals, and their detailed description will be omitted.

The magnetic disk 30 comprises the normal area 31 and the metadata save area 32 which dedicatedly stores the metadata in addition to the normal area 31. The normal area 31 is an area that stores the actual data and the metadata related to the actual data, and the metadata save area 32 is an area in which the same metadata as that stored in the normal area 31 is duplicated and stored. The normal area 31 may store only the actual data, without storing the metadata.

In the magnetic disk 30, the normal area 31 and the metadata save area 32 are separated from each other by, for example, cylinders, and the metadata save area 32 is set to a cylinder or a cylinder adjacent to the cylinder on each recording surface (platter). This is not limited to the above depending on the characteristics of the storage area of the magnetic disk 30.

In this way, the magnetic disk device 3 can store a plurality of metadata items physically closely with each other in the storage area, so that the magnetic disk device 3 can read the metadata items efficiently during batch reading of the metadata items, regardless of whether the LBAs that specify storage areas of the metadata items are continuous or discontinuous. When the LBAs of all of the metadata items to be batch read are continuous, physical storage areas specified by the LBAs may not be continuous, thereby the seek time and the rotation waiting time to read the metadata items may be required. However, since the magnetic disk device 3 stores a plurality of metadata items physically closely with each other in the storage area, the magnetic disk device 3 can largely suppress the seek time and the rotation waiting time to read the metadata items, so that it becomes possible to significantly improve the reading performance.

Although the normal area 31 is an area in which the storage areas of physical sectors that stores the actual data and the metadata are managed by the LBAs, the metadata save area 32 is an area in which the metadata is stored separately from data other than the metadata, and hence the metadata save area 32 is an area in which the storage areas are not managed by the LBAs.

When the controller 10 receives a request command to batch read metadata from the host device 2, the controller 10 batch reads a plurality of metadata items stored in the metadata save area 32 of the magnetic disk 30 by using the metadata management table, and outputs the result to the host device 2. The processing performed by the controller 10 will be described below in detail.

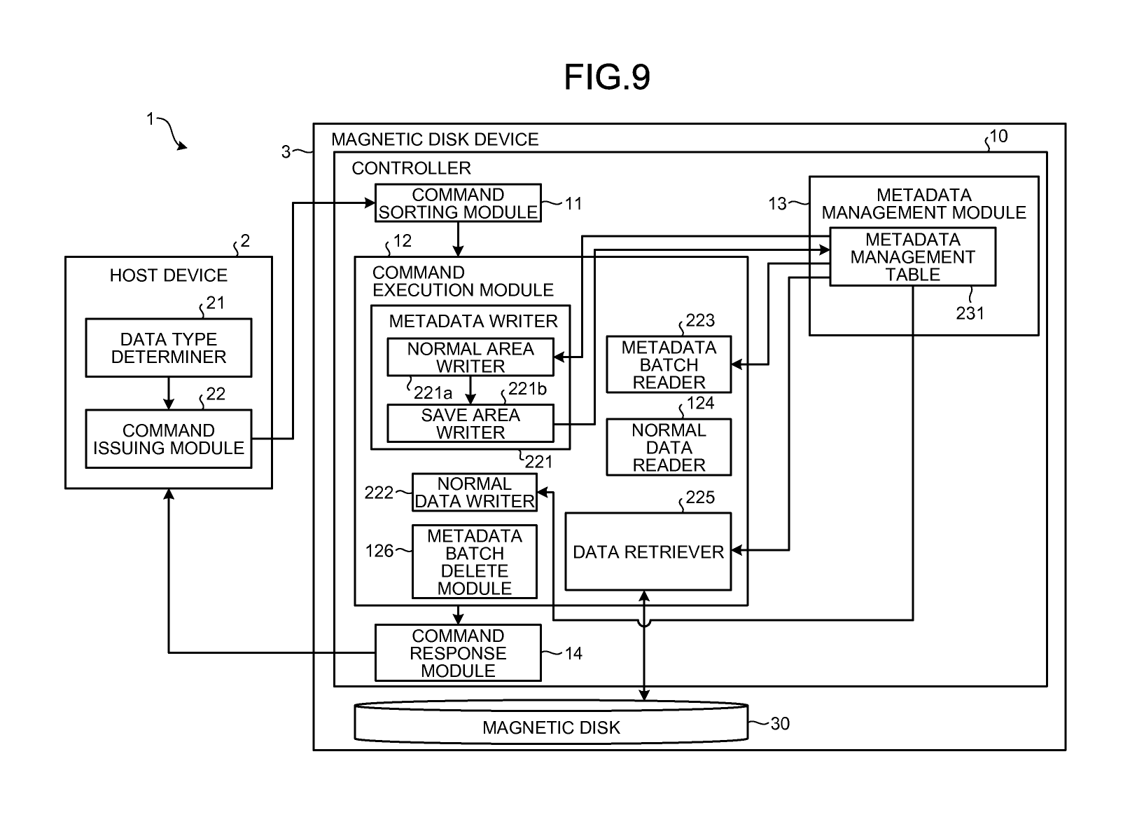

Next, a configuration of the metadata management system according to the second embodiment will be described with reference to FIG. 9. FIG. 9 is a functional block diagram illustrating the configuration of the metadata management system according to the second embodiment. As illustrated in FIG. 9, in the metadata management system 1 according to the second embodiment, a metadata writer 221, a normal data writer 222, a metadata batch reader 223, a data retriever 225, and a metadata management table 231 corresponding to those in the metadata management system 1 according to the first embodiment (FIG. 2) are changed. In FIG. 9, the same portions as those in FIG. 2 are given the same reference numerals, and their detailed description will be omitted.

When the metadata writer 221 receives the metadata save command from the command sorting module 11, the metadata writer 221 writes the metadata to the normal area 31 and the metadata save area 32 of the magnetic disk 30. Further, the metadata writer 221 comprises a normal area writer 221a and a save area writer 221b.

When the normal area writer 221a receives the metadata save command from the command sorting module 11, the normal area writer 221a writes the metadata comprised in parameters of the command to the normal area 31 on the basis of the parameters of the received command.

Specifically, the normal area writer 221a receives parameters comprising the metadata, an LBA specifying the metadata, and an LBA of the actual data corresponding to the metadata. The normal area writer 221a writes the metadata comprised in the received parameters to the normal area 31 so as to use the LBA specifying the metadata. Further, the normal area writer 221a outputs the parameters to the save area writer 221b.

The save area writer 221b writes the metadata to the metadata save area 32. Specifically, when the save area writer 221b receives the parameters from the normal area writer 221a, the save area writer 221b determines whether the LBA of the metadata comprised in the parameters is stored in the metadata management table 231.

When the LBA of the metadata comprised in the parameters is stored in the metadata management table 231, the save area writer 221b determines that an area corresponding to the metadata is already secured in the metadata save area 32, and retrieves an index number that specifies the storage area of the metadata in the metadata save area 32. The save area writer 221b writes the metadata to the metadata save area 32 corresponding to the retrieved index number. Further, the save area writer 221b outputs the write result comprising the index number that specifies the metadata to the command response module 14.

When the LBA of the metadata comprised in the parameters is not stored in the metadata management table 231, the save area writer 221b provides an index number that specifies a storage area of the metadata in the metadata save area 32. Then, the save area writer 221b writes the metadata to the metadata save area 32 corresponding to the provided index number.

The save area writer 221b associates the LBA specifying the metadata, the LBA of the actual data corresponding to the metadata, and the index number specifying the metadata with one another, and stores both LBAs and the index number in the metadata management table 231. Further, the save area writer 221b outputs the write result comprising the index number that specifies the metadata to the command response module 14.

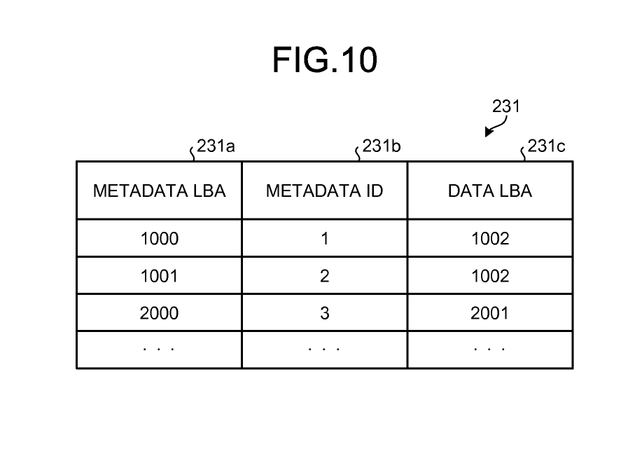

An example of a data structure of the metadata management table 231 will be described with reference to FIG. 10. FIG. 10 is a diagram illustrating the data structure of the metadata management table according to the second embodiment. As illustrated in FIG. 10, the metadata management table 231 comprises, for example, metadata LBAs 231a, metadata IDs 231b indicating index numbers that specify metadata items, and data LBAs 231c. All the metadata items stored in the metadata save area 32 of the magnetic disk 30 can be recognized by the metadata management table 231.

When the normal data writer 222 receives the “Write” command from the command sorting module 11, the normal data writer 222 writes the actual data comprised in the parameters of the command to the normal area 31 of the magnetic disk 30 on the basis of the parameters of the received command.

Although the normal data writer 222 writes the actual data to the normal area 31 of the magnetic disk 30, when the metadata has already been written to the normal area 31, the normal data writer 122 may receive the LBA of the metadata as a parameter of the command and update the metadata in the normal area 31 and the metadata save area 32 of the magnetic disk 30.

When the metadata batch reader 223 receives the metadata batch read command from the command sorting module 11, the metadata batch reader 123 batch reads the metadata managed by the metadata management table 231 from the metadata save area 32 of the magnetic disk 30 by using the metadata management table 231.

Specifically, the metadata batch reader 223 reads all the index numbers (metadata IDs 231b) that specify the metadata items listed in the metadata management table 231. Also, the metadata batch reader 223 reads metadata items from storage areas in the metadata save area 32 specified by the read index numbers. Further, the metadata batch reader 223 outputs all the metadata items read from the metadata save area 32 along with the index numbers (metadata IDs 231b) of the metadata items to the command response module 14. In this way, the metadata batch reader 223 can batch read the metadata items managed by the metadata management table 231 from the metadata save area 32 of the magnetic disk 30.

Although the metadata batch reader 223 batch reads the metadata items from the metadata save area 32 by using the metadata management table 231, the metadata batch reader 223 may batch read all the metadata items without using the metadata management table 231.

When the data retriever 225 receives the corresponding data retrieve command from the command sorting module 11, the data retriever 225 reads an LBA of the actual data corresponding to the metadata comprised in the parameters from the metadata management table 231 on the basis of the parameters of the received command.

Specifically, the data retriever 225 receives an index number specifying the metadata as the parameter. Then, the data retriever 225 reads the LBA of the actual data corresponding to the metadata from the metadata management table 231 by using the received index number specifying the metadata. Further, the data retriever 225 outputs the read LBA that specifies the actual data to the command response module 14.

Although the data retriever 225 reads the LBA of the actual data corresponding to the metadata from the metadata management table 231, the data retriever 225 may further read the actual data from the normal area 31 by using the read LBA of the actual data.

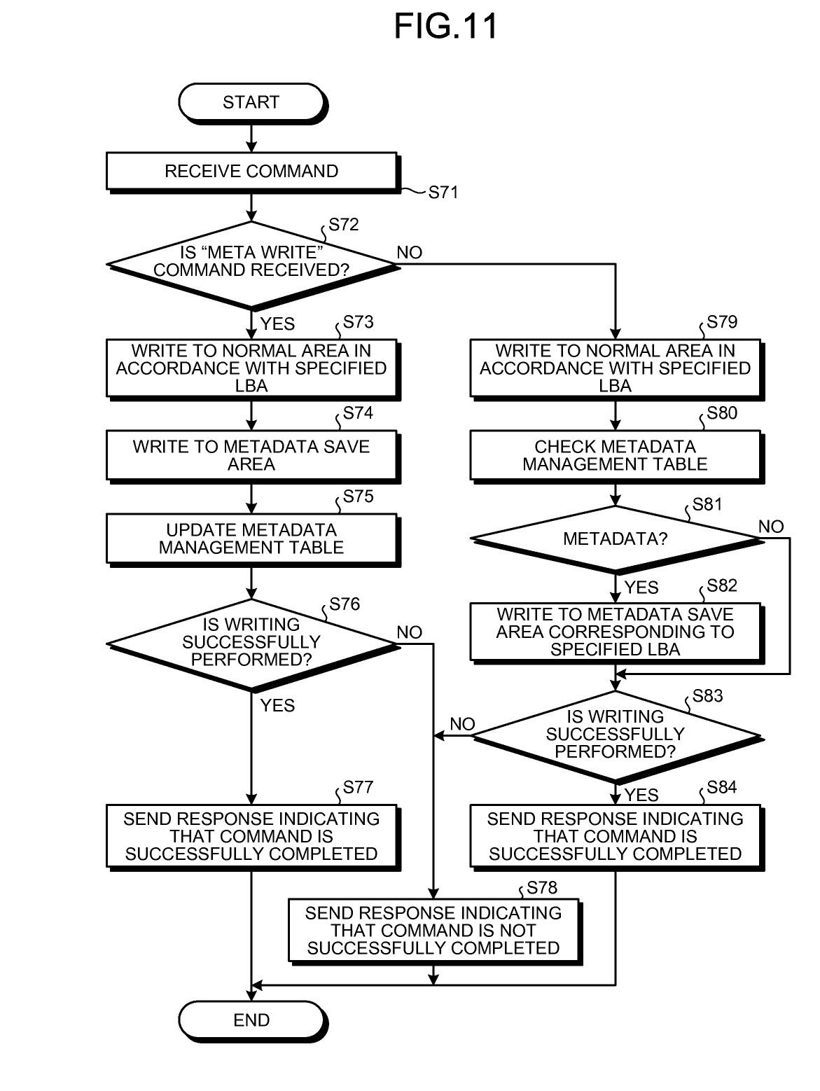

Next, data write processing in the magnetic disk device 3 according to the second embodiment will be described with reference to FIG. 11. FIG. 11 is a flowchart of the data write processing of the magnetic disk device according to the second embodiment. The data write processing in the host device 2 is the same as the data write processing (FIG. 4) in the host device 2 according to the first embodiment, thereby the explanation thereof will be omitted.

First, when a command issued by the command issuing module 22 of the host device 2 is received by the command sorting module 11 (S71), the command sorting module 11 determines whether the received command is the metadata save command (for example, “Meta Write” command) (S72).

When the command sorting module 11 determines that the received command is the metadata save command (for example, “Meta Write” command) (Yes at S72), the normal area writer 221a receives the parameters of the metadata save command comprising the metadata, the LBA specifying the metadata, and the LBA specifying the actual data corresponding to the metadata.

Then, the normal area writer 221a writes the metadata to the normal area 31 so as to use the LBA specifying the metadata in accordance with the received parameters (S73).

Next, the save area writer 221b determines whether the LBA of the metadata comprised in the parameters is stored in the metadata management table 231. When the LBA is stored, the save area writer 221b writes the metadata to a storage area corresponding to the index number corresponding to the LBA in the metadata save area 32. On the other hand, when the LBA is not stored, the save area writer 221b provides an index number that specifies a storage area in the metadata save area 32, and writes the metadata to the storage area corresponding to the index number in the metadata save area 32 (S74).

Further, when the LBA is not stored, the save area writer 221b associates the LBA specifying the metadata, the LBA of the actual data corresponding to the metadata, and the index number specifying the metadata with one another, and stores both LBAs and the index number in the metadata management table 231 (S75).

Thereafter, the command response module 14 receives a response result of the metadata write processing from the save area writer 221b, and determines whether the received response result indicates that the write processing is successfully performed (S76).

When the response result is determined to indicate that the write processing is successfully performed (Yes at S76), the command response module 14 send a response to the command issuing module 22 of the host device 2 indicating that the “Meta Write” command is successfully completed (S77). This response result comprises the index number that specifies the metadata.

When the response result indicates failure in the write processing (No at S76), the command response module 14 sends a response to the command issuing module 22 of the host device 2 indicating that the “Meta Write” command is not successfully completed (S78).

On the other hand, when the command sorting module 11 determines that the command is not the metadata save command (for example, “Meta Write” command) (No at S72), the normal data writer 222 determines that the command is the “Write” command, and receives the parameters of the “Write” command comprising the actual data and an LBA specifying the actual data. Then, the normal data writer 222 writes the data to the normal area 31 so as to use the LBA specifying the data in accordance with the received parameters (S79).

Further, for a case to write the metadata which has already been stored in the normal area 31 by the “Write” command, the normal data writer 222 determines whether the LBA that specifies the data comprised in the parameters is stored in the metadata management table 231 (S80).

When the LBA that specifies the data is determined to be stored in the metadata management table 231 (Yes at S81), the normal data writer 222 determines that the data is the metadata, and writes the data to a storage area corresponding to the index number corresponding to the LBA of the data in the metadata save area 32 (S82). The purpose of this is to maintain consistency of the metadata between the normal area 31 and the metadata save area 32.

After the data is written to the metadata save area 32, or when the LBA that specifies the data is determined not to be stored in the metadata management table 231 (No at S81), the command response module 14 receives a response result of the actual data write processing from the normal data writer 222, and determines whether the received response result indicates that the write processing is successfully performed (S83).

When the response result indicates that the write processing is successfully performed (Yes at S83), the command response module 14 sends a response to the command issuing module 22 of the host device 2 indicating that the “Write” command is successfully completed (S84).

When the response result indicates failure of the write processing (No at S83), the command response module 14 sends a response to the command issuing module 22 of the host device 2 indicating that “Write” command is not successfully completed (S78).

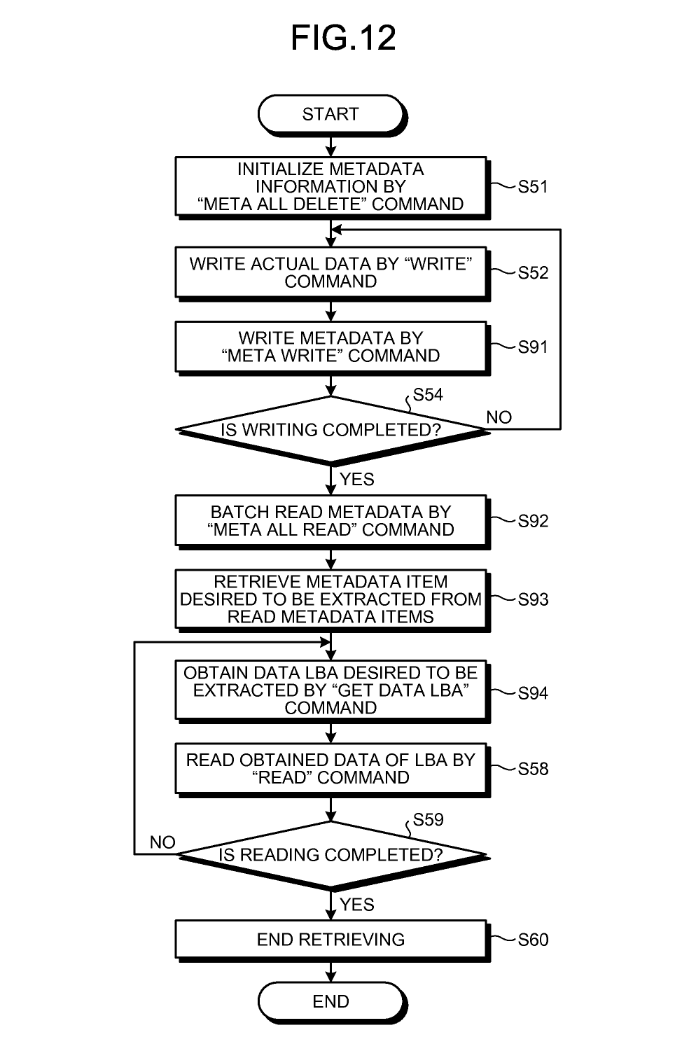

Next, a use example of the metadata management system according to the second embodiment will be described with reference to FIG. 12. FIG. 12 is a flowchart illustrating the use example of the metadata management system according to the second embodiment. In FIG. 12, the same portions as those in the use example (FIG. 7) of the metadata management system according to the first embodiment are given the same reference numerals, and their detailed description will be omitted.

First, to initialize the metadata management table 131, when the metadata batch delete module 126 of the magnetic disk device 3 receives the metadata batch delete command (“Meta All Delete” command) from the host device 2, the metadata batch delete module 126 deletes all the metadata items listed in the metadata management table 231 (S51).

Next, to store the actual data in the magnetic disk 30, when the normal data writer 222 receives the “Write” command from the host device 2, the normal data writer 222 stores the actual data specified by the command in the normal area 31 of the magnetic disk 30 (S52).

Next, to store the metadata related to the actual data information to the magnetic disk 30, the command issuing module 22 of the host device 2 issues the metadata save command (“Meta Write” command). Then, the metadata writer 221 stores the metadata specified by the command in the normal area 31 and the metadata save area 32 of the magnetic disk 30 (S91). At this time, the metadata writer 221 associates the LBA specifying the metadata specified by the command, the LBA specifying the actual data corresponding to the metadata, and the index number specifying the metadata with one another, and stores both LBAs and the index number in the metadata management table 231.

The host device 2 determines whether the write processing of the actual data to the magnetic disk 30 is completed (S54).

When the write processing of the actual data to the magnetic disk 30 is determined not to be completed (No at S54), the host device 2 moves to S52 to continuously store the actual data not having been written in the magnetic disk 30.

On the other hand, when the host device 2 determines that the write processing of the actual data to the magnetic disk 30 is completed (Yes at S54), the host device 2 completes the write processing. Thereafter, to read all the metadata items stored in the metadata save area 32 of the magnetic disk 30, the command issuing module 22 of the host device 2 issues the metadata batch read command (“Meta All Read” command). Then, the metadata batch reader 223 reads all the metadata items listed in the metadata management table 231 from the metadata save area 32 (S92), and send a response to the host device 2 with all the read metadata items and the index numbers thereof.

Then, the host device 2 retrieves an index number of a metadata item related to an actual data information desired to be extracted from all the metadata items read by the magnetic disk device 3 (S93).

To obtain the LBA of the actual data corresponding to the retrieved metadata item, the command issuing module 22 of the host device 2 issues the corresponding data retrieve command (“Get Data LBA” command) in which the index number of the metadata related to the actual data information. Then, the data retriever 125 reads the LBA of the actual data corresponding to the metadata from the metadata management table 231 (S94) by using the index number which is specified by the command and specifies the metadata, and responds to the host device 2 with the read LBA of the actual data.

Further, to read the actual data from the magnetic disk 30, when the normal data reader 124 receives the “Read” command that specifies the LBA of the actual data from the host device 2, the normal data reader 124 reads the actual data from the normal area 31 (S58) by using the received LBA of the actual data, and send a response to the host device 2 with the read actual data.

The host device 2 determines whether the read processing of the actual data desired to be extracted from the magnetic disk 30 is completed (S59).

When the host device 2 determines that the read processing of the actual data desired to be extracted from the magnetic disk 30 is not completed (No at S59), the host device 2 performs S94 to continuously read the actual data not having been read from the magnetic disk 30.

On the other hand, when the host device 2 determines that the read processing of the actual data desired to be extracted from the magnetic disk 30 is completed (Yes at S59), the host device 2 completes the read processing of the actual data (S60).

As described above, the second embodiment comprises the magnetic disk 30 comprising the normal area 31 that stores a plurality of metadata items related to the actual data items to be retrieved for each actual data item and the metadata save area 32 that dedicatedly stores the metadata, manages the logical addresses (metadata IDs 231b) specifying the metadata items stored in the magnetic disk 30 for each of the metadata items, and reads metadata items related to the actual data items from the magnetic disk 30 by using the managed logical addresses specifying the metadata items.

According to such a configuration, the magnetic disk device 3 can recognize storage areas of the metadata items stored in the metadata save area 32 that dedicatedly stores the metadata by using the metadata management table 231, so that the magnetic disk device 3 can efficiently read the plurality of metadata items. As a result, the magnetic disk device 3 can largely suppress the seek time and the rotation waiting time, and hence it is possible to significantly improve the performance of the batch read processing of the metadata. Further, the magnetic disk device 3 can optimize the performance of the batch read processing of the metadata without changing operations of existing BIOS, OS, and the like of the host device.

In addition, since the magnetic disk device 3 physically stores a plurality of metadata items as a whole in a specific area in the magnetic disk 30, regardless of sequentiality of the LBAs that specify the metadata items, the magnetic disk device 3 can largely suppress the seek time and the rotation waiting time to read each metadata item, so that it becomes possible to significantly improve the reading performance.

The illustrated constituent elements of the host device 2 and the magnetic disk device 3 represent a functional concept, and the constituent elements are not necessarily constituted physically as illustrated in the figures, so that a specific embodiment of the metadata management system 1 is not at all limited to those illustrated in the figures.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic disk device comprising:
a recording medium configured to record a plurality of metadata for a plurality of search data, the metadata comprising information of the search data;
a management module configured to manage, for each metadata, logical addresses specifying the metadata recorded in the recording medium; and
a reader configured to read the metadata from the recording medium by using the logical addresses.

2. The magnetic disk device of claim 1, wherein the reader is configured to read, when the reader detects a request to read the metadata, the metadata corresponding to the logical addresses from the recording medium.

3. The magnetic disk device of claim 1, wherein
the recording medium comprises a dedicated recording area for the metadata, and
the reader is configured to read the metadata corresponding to the logical addresses from the dedicated recording area.

4. The magnetic disk device of claim 3, wherein:
the recording medium comprises a plurality of cylinders; and
the dedicated recording area comprises one cylinder and optionally an adjacent cylinder.

5. The magnetic disk device of claim 3, further comprising a writer configured to write, when the writer detects a request to write a metadata to the recording medium as one of the metadata items stored in the recording medium, the metadata item corresponding to the request to the dedicated recording area.

6. The magnetic disk device of claim 5, wherein the writer is configured to store a logical address specifying the metadata corresponding to the request in the management module, as one of the logical addresses.

7. The magnetic disk device of claim 1, further comprising a delete module configured to delete, when the delete module detects a request to delete at least one of the logical addresses.

8. A metadata management system, comprising:
a magnetic disk device comprising a recording medium configured to record a plurality of metadata for a plurality of search data, the metadata comprising information of the search data items; and
a host device configured to transmit a request to the magnetic disk device, wherein
the host device comprises a read request module that is configured to output a read request to read the metadata, and
the magnetic disk device comprises
a management module that is configured to manage, for each of the metadata, logical addresses specifying the metadata recorded in the recording medium,
a reader that is configured to read, when the reader detects the read request from the read request module, the metadata by using the logical addresses, and
an output module that is configured to output to the host device the metadata read by the reader, along with the logical addresses specifying the metadata.

9. The metadata management system of claim 8, wherein
the management module is configured to associate the logical addresses specifying the metadata and logical addresses specifying the search data, and
a retriever is configured to retrieve, when the retriever detects a retrieve request for retrieving one of the search data associated with one of the metadata specified from the metadata output by the output module, the one of the search data requested to be retrieved from the recording medium by using the logical addresses specifying the search data items.
